(19) United States
(12) Patent Application Publication
(10) Pub. No.: US 2003/0152171 A1
(43) Pub. Date: Aug. 14, 2003

(54) METHOD FOR INITIALIZING A VITERBI DECODER IN FRAMED MODE

(76) Inventors: PAUL SPENCER, BET SHEMESH (IL); HAIM KUPERSHMIDT, OR YEHUDA (IL)

Correspondence Address: Kenneth J. Cool, Blakely, Sokoloff, Taylor & Zafman, 12400 Wilshire Boulevard, Seventh Floor, Los Angeles, CA, 90025, US

(21) Appl. No.: 09/205,600

(22) Filed: Dec. 4, 1998

(30) Foreign Application Priority Data
Dec. 7, 1997 (IL) 122496

(51) Int. Cl. H03D 1/00; H04L 27/06

(52) U.S. Cl. 375/341

(57) ABSTRACT

A method for initializing a VITERBI mechanism is provided. The general environment in which such a method is implicated is a state matrix which includes a plurality of stages, each of the stages including a plurality of potential states, having a VITERBI mechanism for analyzing a received signal, wherein the received signal defines a trail of states. The trail of states includes a single state at each of the stages and the signal includes a predetermined initial state. The VITERBI mechanism detects the trail.

### FIELD OF THE INVENTION

The present invention relates to a method for signal processing in general and to a method for initializing a viterbi decoder in a framed mode in particular.

### BACKGROUND OF THE INVENTION

Methods for processing a received signal so as to determine the most likely data incorporated therein, are known in the art.

Reference is now made to FIG. 1 which is a schematic illustration of data transitions known in the art. States 10, 12, 14 and 16 are data states of a right shifted shift register, wherein the shift is performed from the least significant digit (i.e., the right digit).

Thus, state 12 (0,0,0) can be shifted, according to data transition 24, into state 16 (0,0,0) wherein 0 is shifted in. Alternatively, state 12 (0,0,0) can be shifted, according to data transition 20, into state 14 (0,0,1) wherein 1 is shifted in. Accordingly, state 10 (1,0,0) can be shifted, according to data transition 22, into state 16 (0,0,0) wherein 0 is shifted in. Alternatively, state 10 (1,0,0) can be shifted, according to data transition 20, into state 14 (0,0,1) wherein 1 is shifted in.

Each of the states and transitions determined a metric M. In the present example, M₁₀ and M₁₂ are the metrics of states 10 and 12, respectively, M_{12,16} is the metric of transition 24, from state 12 to state 16, M_{12,14} is the metric of transition 26 from state 12 to state 14, M_{10,14} is the metric of transition 20, from state 10 to state 14 and M_{10,16} is the metric of transition 22, from state 10 to state 16.

The metric M₁₆ of state 16 is determined by the expression:

M₁₆=min(M₁₂+M_{12,16}, M₁₀+M_{10,16})

Thus, the trail from one state to the other can be estimated using the metric of the states and the transitions. A viterbi decoder uses this metric to determine the most likely transition. Conventionally, the trail of transitions is determined backwards. Thus even if there is a selected trail which has the best likelihood value, for a selected state in the state table, a later state may cause an alternative trail to have an even better likelihood value, shifting the focus of the system from the current trail to the alternative one.

It will be appreciated that determining a metric of a state may be provided using either minimum or maximum operations, whichever is more convenient.

The implementation of the above expression in hardware is called an add-compare-select module (ACS), wherein the metric of each state is added to the metric of the respective transition, then the results of these adding operations are compared and finally, one of which is selected.

Each of these metrics has given a weight according to their likelihood of the occurrence.

Reference is now made to FIG. 2 which is a schematic illustration of a state matrix, referenced 54, known in the art.

Matrix 54 is an M by N state matrix, which represents all of the variations of the states and transitions from an initial state, selected from the left side column (#,0), to a final state, selected from the right side column (#,M). Column (#,0) is also called the initial state column.

State 52 (3,M) is a selected final state in the matrix 54 and the rout which led to it is determined by a viterbi decoder. In the present example, the Viterbi decoder produces two routs which may have led to state 52. A first rout 60 which starts at state 50 (1,0) and a second rout 62, starting at state 56 (3,0).

When working in framed mode, it is common to predetermine a selected initial state, which in the present example is state 50, provide a minimal value as its metric value, which in the present example is zero and provide high values as the metric values of the rest of the initial states (0,0), (2,0), (3,0)-(N,0), as high as the system enables. It will be appreciated that software implementations provide metric values, which are sufficiently high, since a variable size in software is generally dynamic and can be determined at any desired length.

However, hardware implementations are known to be limited in variable size, since they often have to comply with other requirements such as small physical size, high efficiency and the like.

Accordingly, conventional hardware implemented methods do not use the entire variable length, rather a modulo representation. For example, if the variable length is eight bits but the highest difference between two states is four bits, than these methods would rely on a four bit modulo representation instead of an eight bit full value one. It will be appreciated that in accordance with these methods, all of the ACS units as well as any storage area are constructed in a four-bit form, thus reducing considerable amount of hardware

Reference is made to FIGS. 3A and 3B, which are schematic illustrations of modulo representation of a probability based transition, known in the art.

When using a modulo representation or a modulo form of a metric wherein the highest difference between adjacent metrics is Δ, then the variable size can be determined as the maximum length of Δ. Accordingly the behavior of such a variable can be described as a circle, shown in FIG. 3A, wherein vector 100 represents a slight shift from 0 and vector 102 represents a considerable shift from 0. Accordingly vector 102 represents a higher metric difference. In a system that is minimal metric oriented vector 100 will be selected over vector 102 since it is closer to 0 which is represented by the horizontal axis.

Referring now to FIG. 3B, vector 110 represents 0vector 112 represents a slight shift from 0, vector 114 represents a Λ/2 shift from 0 and vector 116 represents a shift which is originally higher than Λ/2. It will be appreciated that a minimum metric procedure selects vectors which are closer to each other in a counter clockwise direction.

Accordingly vector 116 will be selected over vector 112 since its distance from 0 is shorter. In a counter clockwise direction, the angular distance of vector 112 is more than

$$π \frac{3}{2}$$

while the angular distance of vector 116 is less than π. This poses a considerable disadvantage since the system is unable to detect vectors which should have been non selected.

Accordingly the prior art solution results in extending the modulo variable to include an additional bit thus being able to contain a 2Δ value.

Reference is now made to FIG. 4 which is a schematic illustration of a modulo representation of a likelihood metric variable having a variable length of 2×Δ, known in the art.

Vector 120 represents a 0 difference value, as well as a 2×Δ difference value. Vector 122 represents a vector, which is slightly shifted from 0, vector 124 represents a metric value which is considerably shifted from 0 and vector 126 represents the maximal shift which is Δ. Accordingly a minimum metric oriented procedure can detect a minimal shift value easily and select the appropriate vector using its distance from vector 120.

It will be appreciated by those skilled in the art that this solution poses a considerable burden over hardware components, in which it is implemented, since every variable implemented in hardware has to include an extra bit.

Accordingly every ACS unit has to include extra bits in each of its internal parts the adding mechanism, comparing mechanism and selection mechanism, the memory of such a chip has to be extended so that every variable contained therein includes an extra bit. Furthermore the transferring of such excessive data requires additional power. For example, if the variable length of Λ is four bits, than a 2×Δ variable length would be five bits.

### SUMMARY OF THE PRESENT INVENTION

It is an object of the present invention to provide a novel method for initializing a viterbi mechanism.

According to the present invention, there is thus provided a method for initializing a VITERBI mechanism which overcomes the disadvantages of the prior art.

The general environment in which such a method is implicated is a state matrix which includes a plurality of stages, each of the stages including a plurality of potential states, having a VITERBI mechanism for analyzing a received signal, wherein the received signal defines a trail of states. The trail of states includes a single state at each of the stages and the signal includes a predetermined initial state. The VITERBI mechanism detects the trail

The method includes the steps of:

analyzing the received signal using the VITERBI mechanism, thereby determining at least one potential trail of states,

examining the potential trails thereby selecting, from them, a group of trails which include the predetermined initial state,

calculating a likelihood value for each trail within the group of trails, and

selecting an elected trail with the best likelihood value from the group of trails.

According to another aspect of the invention, the method can further include the step of decoding the received signal according to the elected trail.

### BRIEF DESCRIPTION OF THE DRAWINGS

The present invention will be understood and appreciated more fully from the following detailed description taken in conjunction with the drawings in which:

FIG. 1 is a schematic illustration of data transitions, known in the art;

FIG. 2 is a schematic illustration of a state matrix known in the art;

FIGS. 3A and 3B are schematic illustrations of modulo representation of a probability based transition, known in the art.

FIG. 4 is a schematic illustration of a modulo representation a of a likelihood metric variable having a variable length of 2×Δ, known in the art;

FIG. 5 is a schematic illustration of a state matrix, constructed and operative in accordance with a preferred embodiment of the present invention;

FIG. 6 is a schematic illustration of a modulo representation a of a likelihood metric variable having a variable length of Δ, at the initial state, operative according to the present invention; and

FIG. 7 is a schematic illustration of a method for providing viterbi initialization, operative according to the present invention.

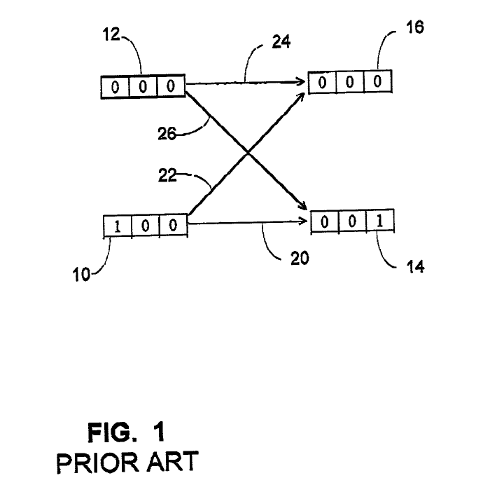

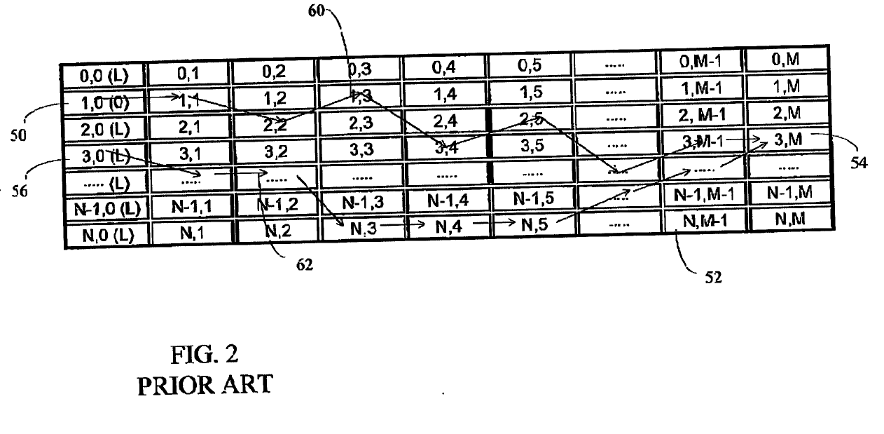

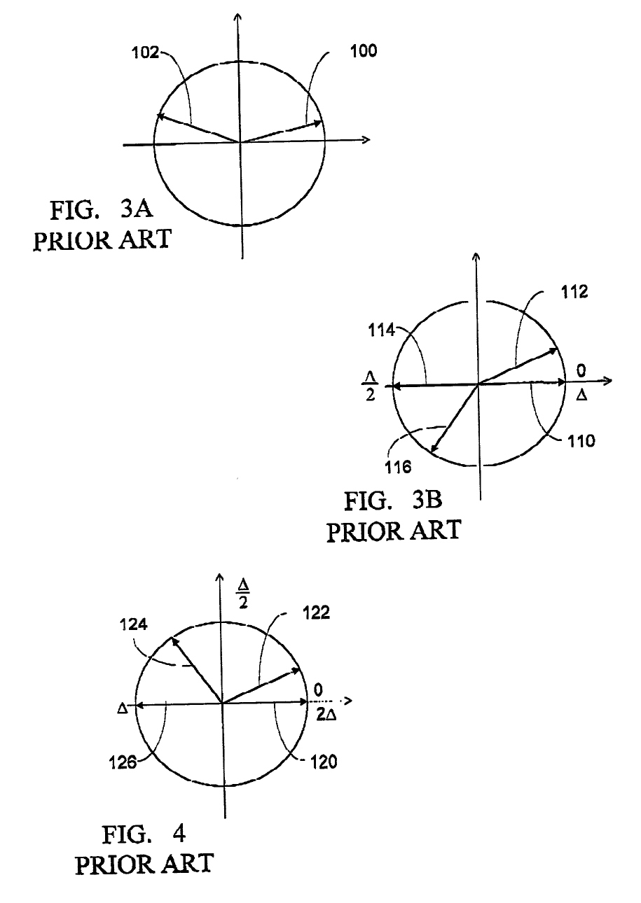

### DETAILED DESCRIPTION OF PREFERRED EMBODIMENTS

The method of the present invention overcomes the disadvantages of the prior art by providing a novel method which improves implementation of a VITERBI algorithm, in framed mode of operation, by enforcing specifically determined boundary states, instead of allowing a probability derived selection from a plurality of boundary states.

In viterbi based implementations such as communication in general and frame based communication, the beginning of any transmission is well defined and is known both to the transmitter and the receiver. This beginning defines an initial state which is a selected state from the initial column (#,0) of the state matrix.

While the prior art provides the best likelihood value to the initial state and the worst likelihood value to all of the rest of the states of the initial column, the present invention, selects the initial state and totally disregards all other potential states of the initial column. In other words, the initial column of a state matrix, according to the present invention, includes a single state which is the initial state.

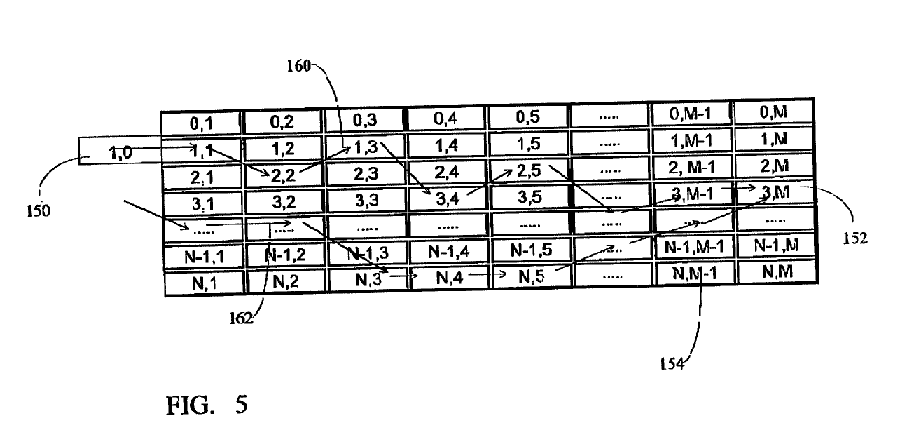

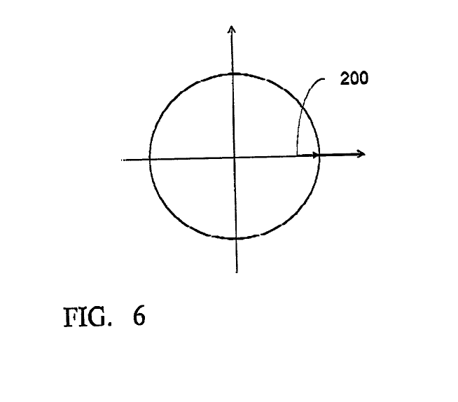

Reference is now made to FIG. 5 which is a schematic illustration of a state matrix, constructed and operative in accordance with a preferred embodiment of the present invention.

Matrix 154 is an M−1 by N state matrix which includes an additional state 150 which replaces the initial state column (#,0) of the prior art matrix 54.

In the present example, a VITERBI decoding mechanism determined two potential trails 160 and 162. Trail 160 is traced back to the initial state 150 while trail 162 is traced back to a state which does not exist in the table. According to the present invention, any trail which is not traced back to the initial state 150, is disposed of.

Reference is also made to FIG. 6 is a schematic illustration of a modulo representation of a likelihood metric variable having a variable length of Δ, at the initial state, operative according to the present invention.

The present invention selects only a metric value 200 which points directly at the predetermined initial state. No other metric values can be selected.

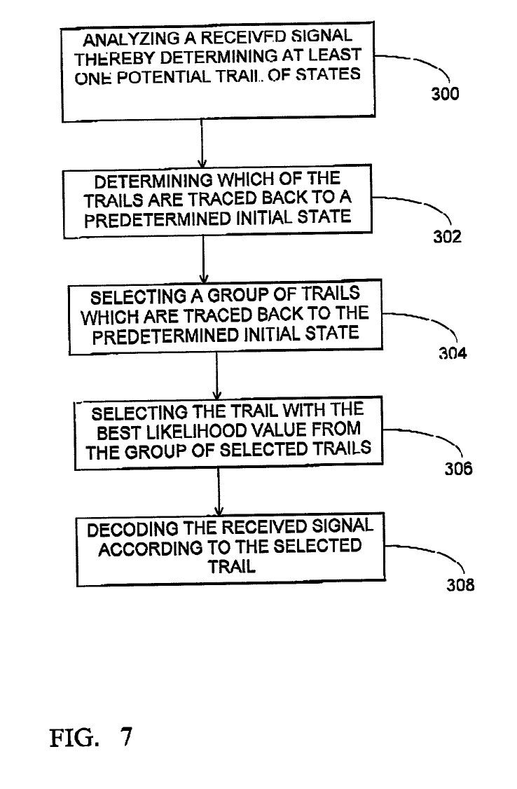

Reference is now made to FIG. 7 is a schematic illustration of a method for providing viterbi initialization, operative according to the present invention.

In step 300, a received signal is analyzed using a VITERBI mechanism so as to determine at least one potential trail of states. It will be appreciated that conventionally, a viterbi mechanism produces a plurality of such potential trails from which the most likely one is finally selected.

In step 302, each of the trails is examined to see if any of them are traced back to a predetermined initial state.

In step 304, a group of trails is selected, wherein each of the trails is traced back to the predetermined initial state.

In step 306, the trails of the selected group are examined according to their likelihood values and the trail that has the best likelihood value is selected therefrom.

In step 308 the received signal is decoded according to the selected trail.

It will be appreciated by persons skilled in the art that the present invention is not limited to what has been particularly shown and described hereinabove. Rather the scope of the present invention is defined only by the claims which follow.

1. In a state matrix including a plurality of stages, each of the stages including a plurality of potential states, a method for initializing a VITERBI mechanism, the VITERBI mechanism analyzing a received signal, the received signal defining a trail of states, the trail of states including a single state at each of the stages, the signal including a predetermined initial state, the VITERBI mechanism detecting the trail, the method comprising the steps of:
analyzing said received signal using said VITERBI mechanism, thereby determining at least one potential trail of states;
examining said at least one potential trail thereby selecting, from said at least one potential trails, a group of trails which include said predetermined initial state;
calculating a likelihood value for each said trail of said group of trails; and
selecting an elected trail with the best likelihood value from said group of trails,

2. The method according to claim 1, further including the step of decoding said received signal according to said elected trail.
